(19) United States
(12) Patent Application Publication
(10) Pub. No.: US 2009/0158941 A1
(43) Pub. Date: Jun. 25, 2009

(54) Combined Food Processor

(75) Inventors: Kuoliang Lee, Taipei City (TW); Chihhao CHEN, Tali Town (TW); Chisbeng Lee, Taipei City (TW); Yuching LIANG, Taipei City (TW)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: TSANN KUEN (CHINA) ENTERPRISE CO., LTD., Fujian (CN)

(21) Appl. No.: 12/325,840

(22) Filed: Dec. 1, 2008

(30) Foreign Application Priority Data
Nov. 30, 2007 (CN) 96220315

(51) Int. Cl. A47J 43/04; B26B 7/00; B26B 15/00

(52) U.S. Cl. 99/537; 30/276; 30/277.4

(57) ABSTRACT

A combined food processor comprising a housing, a motor, a cutter, a container and a switch unit, one end of the housing formed a handle, the other end formed a connecting portion, an opening formed on the connecting portion, the motor has a output shaft and mounted in the housing, the output shaft extending out of the housing and positioned in the opening of the connecting portion of the housing, the cutter has at least a blade and mounted in the opening of the connecting portion of the housing, the container mounted on the connecting portion of the housing, the blade of the cutter arranged in the container, the switch unit mounted on the housing and electrically connecting to the motor; thereby, the users can place food or drink into the container and turn on the switch unit, then the motor will begin to work to drive the blade to rotate so as to cut and mix the food or drink in the container sufficiently.

### FIELD OF THE INVENTION

The invention relates to a combined food processor, particularly to a portable combined food processor which can be used to cut, mix or blender food.

### BACKGROUND OF THE INVENTION

An important component of high quality modern life is the availability of homehold electrical appliances that are aesthetically appealing, practical, user-friendly and a joy to use.

Exiting food processors, for example blenders however usually are bulky, so they must be placed on table tops. Moreover, they are often single-functioned and are inconvenient to be moved. Thus their applications are limited and they are not favored.

Therefore, we provided an invention with reasonable design that overcomes the aforementioned disadvantages.

### SUMMARY OF THE INVENTION

The primary object of the present invention is to provide a combined food processor which is portable and can be used as a hand-held device.

The object is achieved by providing a combined food processor comprising a housing, one end of the housing formed a handle, the other end formed a connecting portion, an opening formed on the connecting portion; a motor having a output shaft, and the motor mounted in the housing, the output shaft extending out of the housing and positioned in the opening of the connecting portion of the housing; a cutter comprising a base, a shaft and at least a blade, the base mounted in the opening of the connecting portion of the housing, the shaft is through the base and pivotally connected to the base, one end of the shaft sleeved with the output of the motor and link to each other, the other end of the shaft extending out the base, the blade has a pivotally connecting end, by which the blade pivotally connected to the other end of the shaft; a container comprising a container body and a cover, the container body has a containing space inside, and the container body formed a first opening and a second opening, the first opening and the second opening positioned in the two ends of the container body respectively and connecting to the containing space, the cover mounted in the second opening of the container and covering the second opening, the container assembled with the connecting portion of the housing via the first opening, the blade of the cutter arranged in the containing space of the container; and a plurality of switches mounted on the housing, the switches electrically connecting to the motor.

The present invention has the following advantages: the users can place food or drink into the containing space of the container and turn on the switches, to start-up the motor to drive the blade, then the blade will rotate to cut and mix the food or the drink sufficiently, the invention is portable and easily-operated, moreover, it has combined functions such as mixing juice, cutting food, making sorbet or cocktail, etc.

A clear conception of the advantages and features constituting the present invention, and of the construction and operation of typical mechanisms provided with the present invention, will become more readily apparent by referring to the following detailed description and the accompanying drawings, understanding that these drawings depict only typical embodiments of the invention and are not therefore to be considered to be limiting of its scope.

### BRIEF DESCRIPTION OF THE DRAWINGS

FIG. 1 is an exploded view of a combined food processor of the present invention.

FIG. 2 is a perspective view of the assembled combined food processor of the present invention.

FIG. 3 is an exploded view of the combined food processor in another embodiment of the present invention.

FIG. 4 is a perspective view of the assembled combined food processor in another embodiment of the present invention.

FIG. 5A is a perspective view of the charger of the combined food processor of the present invention.

FIG. 5B is a perspective view of the assembled charger and the combined food processor of the present invention.

Illustration for the main components:

| | | | |
|---|---|---|---|
| 1 | housing | | |
| 11 | handle | 12 | connecting portion |
| 121 | opening | 122 | slot |
| 2 | motor | | |
| 21 | output shaft | 22 | power source |
| 221 | terminals | 23 | vibration control module |
| 24 | charger | 241 | insert portion |
| 242 | conducting portion | | |
| 3 | cutter | | |
| 31 | base | 32 | shaft |
| 33 | blade | 331 | pivotal connecting end |
| 4 | container | | |
| 41 | container body | 411 | containing space |
| 412 | the first opening | 413 | the second opening |
| 42 | flange | 43 | tenon |
| 44 | cover | 441 | cover body |
| 442 | filter cup | | |
| 5 | switch unit | | |
| 51 | safety switch | 52 | contacting switch |
| 53 | knob | | |
| 6 | mixer | | |
| 61 | base | 62 | tenon |
| 63 | stirring rod | 631 | lamina |

### DETAILED DESCRIPTION OF THE PREFERRED EMBODIMENT

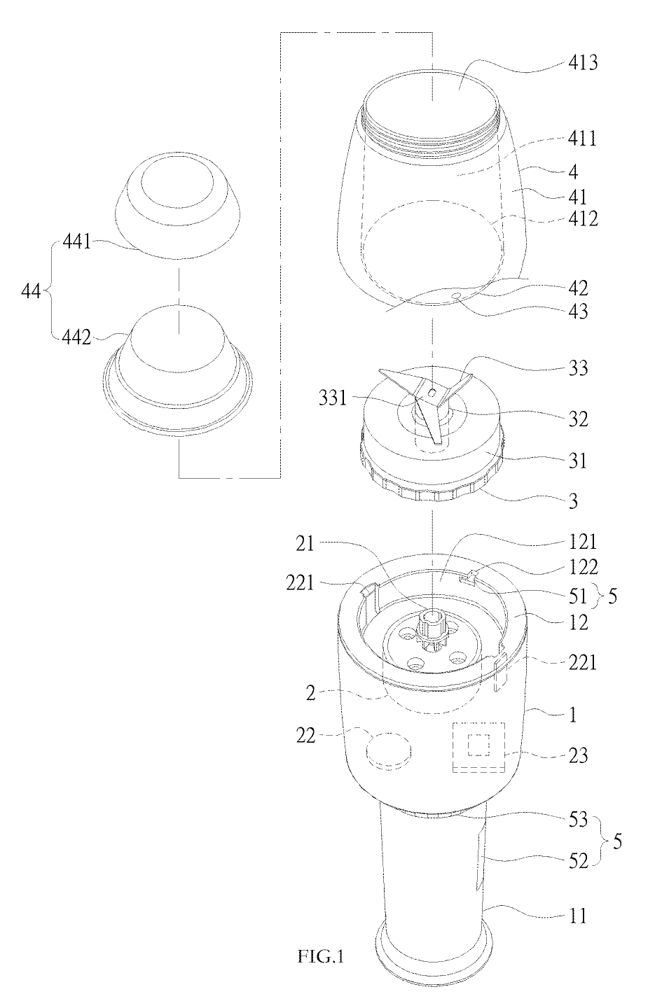

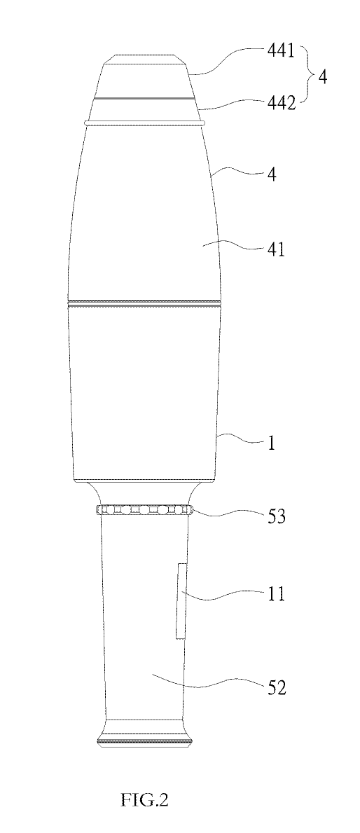

Referring to FIG. 1 and FIG. 2, they illustrate the first embodiment of the combined food processor of the invention, the food processor comprising a housing 1, a motor 2, a cutter 3, a container 4 and a switch unit 5, one end of the housing 1 formed a handle 11, the other end formed a connecting portion 12, the connecting portion 12 formed a opening 121 and has a slot 122, the slot 122 formed on the flange of the opening 121 and is on the inner wall of the opening 121.

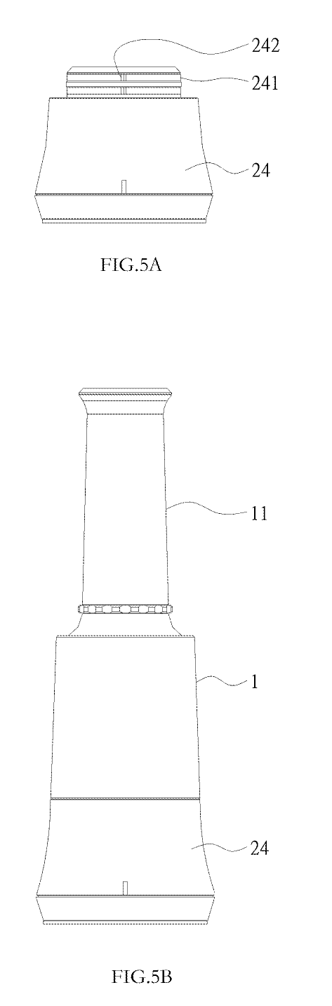

The motor 2 has an output shaft 21 and connecting with a power source 22 and a vibration controlling module 23, the motor 2 mounted in the housing 1, the output shaft 21 extending out the housing 1 and arranged in the opening 121 of the connecting portion 12 of the housing 1, the power source 22 connects with the motor 2 to provide electrify, the power source 22 is an electrical wire connecting to a socket or a rechargeable battery, in this embodiment, the power 22 is a rechargeable battery, the rechargeable battery mounted in the housing 1 and electrically connect to the motor 2 to provide power to the motor 2, and the rechargeable battery has two terminals 221, the two terminals 221 positioned in the inner flange of the opening 121 of the connecting portion 12 of the housing 1, referring to the FIG. 5A and FIG. 5B also, the invention can be incorporated by a charger 24, the charger 24 has an inserting portion 241, the inserting portion 241 has two conducting portion 242 symmetrically corresponding to the two terminals 221, thus the connecting portion 12 of the housing 1 can be combined with the inserting portion 241 of the charger 24, therefore the rechargeable battery can be charged via the electrical connection between the conducting portion 242 of the charger 24 and the two terminals 221. The vibration control module 23 mounted in the housing 1 and electrically connecting to the motor 2, and detecting the vibration to produce a control signal to the motor 2 to control the rotate speed, in this embodiment, when the motor 2 starts-up, the vibration control module 23 will drive the motor 2 increase or decrease the rotate speed according to the vibration frequency detected by the outer vibration.

The cutter 3 has a base 31, a shaft 32 and at least a blade 33, the base 31 mounted in the opening 121 of the connecting portion 12 of the housing 1, and cover the opening 121, the shaft 32 is through the base and pivotally connected to the base 31, one end of the shaft 32 sleeved with the output shaft of the motor 2 and link to each other, the other end of the shaft 32 extending out the base 31, the blade 33 have a pivotally connecting end 331, by which the blade 33 pivotally connected to the other end of the shaft 32.

the container 4 comprising a container body 41, a flange 42, a tenon 43 and a cover 44, the container body 41 has a containing space 411 inside and a first opening 412 and a second opening 413, the first opening 412 is in one end of the container body 41, and the second opening 413 is in the other end of the container body 41, the first opening 412 and the second opening 413 communicate with containing space 411, the flange 42 is formed from the inner side of the first opening 412 of the container body 41 by extending away the body 41. In this embodiment, the outer diameter of the flange 42 is smaller than the outer diameter of the container body 41, and can insert between the inner wall of the opening 121 of the connecting portion 12 of the housing 1 and the base 31 of the cutter 3. The tenon 43 formed in the outer portion of the flange 42 and is near to the first opening 412, in this embodiment, the tenon 43 formed in the outer portion of the flange 42 and is corresponding to the slot 122 of the connecting portion 12 of the housing 1. The cover 44 mounted on the second opening 413 and cover the second opening 413. In this embodiment, the cover 44 comprising a filter cup 442 and a cover body 441, the cover body 441 superposition on the filter cup 442. The container 4 mounted on the connecting portion 12 of the housing 1 separate ably via the first opening 412, the tenon 43 insert in the slot 122 to open the safe switch 51, the flange 42 mesh with the cutter 3 to cover the first opening 412 of the container body 41, the blade 33 of the cutter 3 is in the containing space 411 and is near the first opening 412.

The switch unit 5 mounted on the housing 1 and electrically connecting to the motor 2 and the power 22, to control the start-up, stop or the rotate speed of the motor 2, in this embodiment, the switches comprise a safety switch 51, a contacting switch 52 and a knob 53, without limitation, the switch unit 5 also can be designed in the forms of buttons, knobs, contacting switches or sound switches, and the number of the switch unit 5 is not limited also. The safety switch 51 mounted in the slot 122 of the connecting portion 12 of the housing 1, when the container 4 mounted on the housing 1 and the tenon 43 of the body 41 insert in the slot 122, the safety switch 51 will be turned on, the contacting switch 52 and the knob 53 mounted on the handle 11 of the housing 1 and electrically connected with the motor 2, only when the safety switch 51, contacting switch 52 and the knob 53 are all opened, then the motor 2 can rotate, the rotate speed of the motor 2 can be adjusted by turning the knob 53.

By abovementioned structure of the invention, when the cutter 3, the container 4 assembled on the housing 1, the user can hold the handle 11 of the housing 1 to let the connecting portion 12 of the housing 1 towards up, thus the tenon 43 inserted in the slot 122 to open the safety switch 51, only when the handle 11 hold by the hand of the user to open the contacting switch 52 and the user turns on the knob 53, the motor 2 can be start-up, and the user can open the cover 44 to add food or drink into the containing space 411 from the second opening 413. By aforementioned steps to start-up the motor 2, the food will be cut and mixed up by the rotating of the blade 33 in the container 411, moreover, the user can place the cover 44 on the second opening 413 of the container body 41, and shake the invention in the manner of using a shaker, then the vibration control module 23 will detect the vibration to produce a control signal to adjust the rotate speed of the motor 2, so as to provide food processing actions such as blending juice, cutting food, making smoothie or cocktail. etc. for the user.

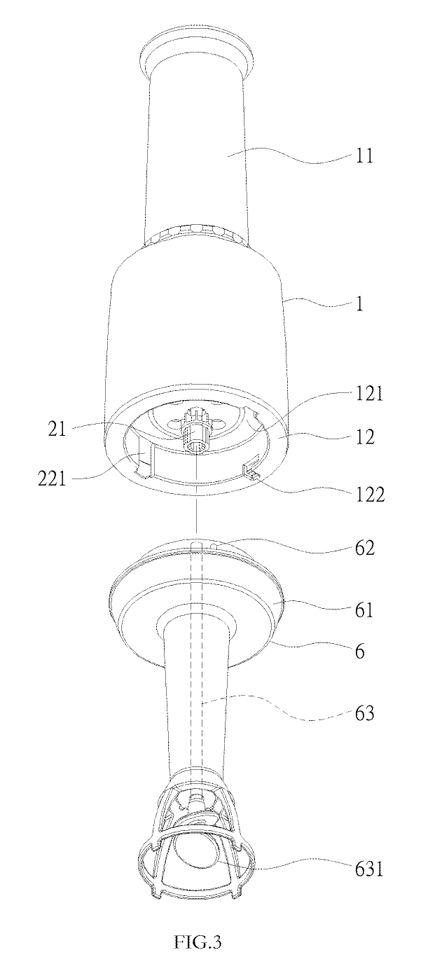

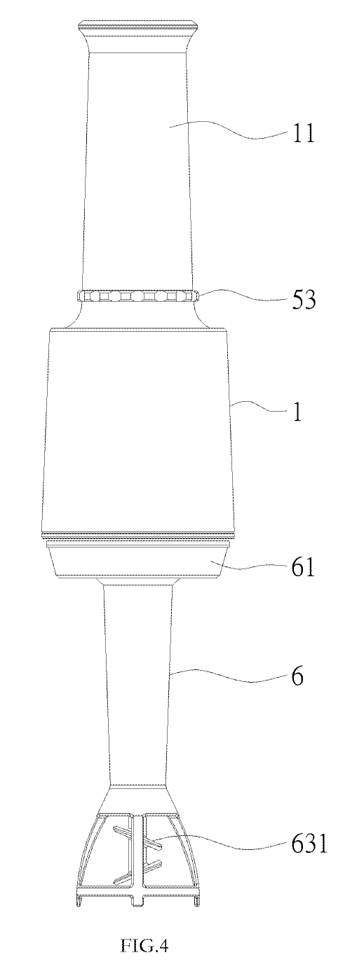

Referring to FIG. 3 and FIG. 4, they illustrate another embodiment of the combined food processor of the invention, in this embodiment, the cutter 3 and the container 4 are replaced by a mixer 6, the mixer 6 comprises a base 61, a tenon 62 and a stirring rod 63, the base 61 mounted in the opening 121 of the connecting portion 12 of the housing 1, and covering the opening 121, the tenon 62 formed in one side of the base 61 where connected to the connecting portion 12 of the housing 1, and insert in the slot 122 of the connecting portion of the housing 1 to open the safety switch 51 The stirring rod 63 is through the base 61 and one end of the rod 63 is sleeved with the output shaft 21 of the motor 2 and link to each other, while the other end extending out the base 61, the stirring rod 63 has a plurality of lamina 631, the lamina 631 mounted on the stirring rod 63 and are near the other end, thus in this embodiment, the user can hold the handle 11 of the housing 1 (to open the contacting switch 52) to let the connecting portion 12 of the housing 1 towards down, thus turning the knob 53 to start the motor 2, the motor 2 will drive the stirring rod 63 of the mixer 6 to rotate via the output shaft 21, to provide mixing actions such as blending egg, mixing milk shake, etc. for the user.

In this invention, by the tenon 43 of the container body 41 or the tenon 62 of the mixer 6 inserting in the slot 122 of the connecting portion of the housing 1 to open the safety switch 51, and the motor 2 must be started-up by the user holding the handle 11 of the housing 1 to start the contacting switch 52 and by turning on the knob 53, thus it can avoid that the motor still rotate when the cutter is exposed, or avoid that the motor still rotate when the handle 11 of the housing 1 is not hold by the user. And the components mounted on the connecting portion 12 of the housing 1 of the invention can be replaced, for example, if the cutter 3 and the container 4 are mounted, the user can hold the handle 11 of the housing 1 and let the connecting portion 12 towards up, then the invention is a wireless blender, if the mixer 6 is mounted, the user can hold the handle 11 of the housing 1 and the connecting portion 12 towards down, then the invention is a wireless electrical mixer, moreover, the rotate speed of the motor 2 can be controlled by the vibration control module 23, this not only can provide different rotate speeds of the motor 2 for different food processing requirement to the user, and facility the user to shake in the food processing action by holding.

In conclusion, by mounting different components (for example, cutter 3 and container 4, or the mixer 6) on the connecting portion 12 of the housing 1, the invention can provide at least a toward-up and a toward-down status to the users, thus the invention has the functions of food processor, blender and mixer etc. to meet the different processing requirements of various food. The handle 11 of the housing 1 make the holding and taking of the invention conveniently, and can operated in different manners according to the different food types (for example mixing drink by shaking up and down), therefore the invention both is practical and of using function.

From the foregoing it will be appreciated that, although specific embodiments of the invention have been described herein for purposes of illustration, various modifications may be made without deviating from the spirit and scope of the invention as defined by the appended claims.

What is claimed is:

1. A combined food processor comprising:
a housing, wherein one end of the housing forms a handle, the other end forms a connecting portion;
a motor having an output shaft, wherein the motor is mounted in the housing, and the output shaft extends out of the housing and is positioned in the opening of the connecting portion of the housing;
a cutter mounted on the output shaft;
a container mounted on the connecting portion, wherein the cutter is positioned in a containing space inside the container; and
at least one switch unit mounted on the housing, wherein the switch unit is electrically connected to the motor.

2. The combined food processor according to claim 1, wherein the cutter comprises a base, a shaft and at least one blade.

3. The combined food processor according to claim 1, wherein an opening is formed on the connecting portion.

4. The combined food processor according to claim 3, wherein the cutter comprises a base, a shaft and at least a blade, wherein the base is mounted in the opening of the connecting portion of the housing, the shaft goes through the base and is pivotally connected to the base, one end of the shaft is sleeved with and links to the output shaft of the motor, and the other end of the shaft extends out of the base, the blade is pivotally connected to the other end of the shaft via pivotal point.

5. The combined food processor according to claim 1, wherein the container comprising a container body and a cover, the container body having a containing space inside.

6. The combined food processor according to claim 5, wherein the container body has a first opening and a second opening, wherein the first opening and the second opening are positioned at the two ends of the container respectively and are connected the containing space, and wherein the cover is mounted in the second opening of the container and covers the second opening, and the container is mounted on the connecting portion of the housing via the first opening of the container body.

7. The combined food processor according to claim 5, wherein the cover comprises a cover body and a filter cup which is super-positioned on the filter cup.

8. The combined food processor according to claim 1, wherein the at least one switch unit further comprises a plurality of switches which are mounted on the housing and are electrically connected to the motor.

9. The combined food processor according to claim 8, wherein the switches comprises a safety switch, a contacting switch and a knob, wherein the safety switch is mounted on the connecting portion of the housing, and the contacting switch and the knob are mounted on the handle of the housing.

10. The combined food processor according to claim 1, wherein the motor is connected to a power source.

11. The combined food processor according to claim 10, wherein the power source is an electrical wire connected to a socket or a rechargeable battery.

12. The combined food processor according to claim 1, wherein the motor is connected to a vibration control module, which is mounted in the housing and can detect vibrations to produce control signals to the motor to control the rotate speed of the motor.

13. The combined food processor according to claim 1, wherein the cutter and the container are detachably mounted on the housing.

14. A combined food processor comprising:
a housing, wherein one end of the housing forms a handle, the other end forms a connecting portion;
a motor having an output shaft, wherein the motor is mounted in the housing, and the output shaft extends out of the housing and is positioned in the opening of the connecting portion of the housing;
a mixer mounted on the output shaft;
at least one switch unit mounted on the housing, wherein the switch unit is electrically connected to the motor.

15. The combined food processor according to claim 14, wherein the mixer comprises a base and a stirring rod, the base is mounted on the connecting portion of the housing, and the stirring rod is through the base, wherein one end of the stirring rod is sleeved with and links to the output shaft of the motor, while the other end extending out of the base.

16. The combined food processor according to claim 15, wherein the stirring rod has a plurality of lamina mounted near the other end of the stirring rod.
